(19) United States
(12) Patent Application Publication
(10) Pub. No.: US 2011/0308167 A1
(43) Pub. Date: Dec. 22, 2011

(54) GATE

(75) Inventor: Thomas Sanvik, Norrkoping (SE)

(73) Assignee: OSTERGOTLANDS FASTIGHETSSERVICE EL OCH LARM I NORRKOPING AB, Norrkoping (SE)

(21) Appl. No.: 13/148,346

(22) PCT Filed: Feb. 4, 2010
(86) PCT No.: PCT/SE2010/000027

§ 371 Date: Aug. 8, 2011

(30) Foreign Application Priority Data
Feb. 12, 2009 (SE) 0900174-4

(51) Int. Cl. E06B 11/02; E05B 65/06

(52) U.S. Cl. 49/394

(57) ABSTRACT

A gate (1a-b, 2a-b) with a stand (1a-b) and a rotatable part (2a-b) that is turnable or rotatable relative to the stand. The rotatable part (2a-b) is attached to the stand via a generator. The gate may be latched by electrically loading the electrical output of the generator, which does not necessitate a separate latch element, and the generator may further be used for generating electrical power that is used for control of control electronics in the gate. The generator may further be arranged to break the rotatable part (2a-b), or alternatively act as a motor turning or rotating the rotatable part (2a-b). A gate where the generator is arranged to rotate an integer fraction of one full turn, and which may be used with a turnstile, is also described.

The present invention relates to a gate according to the introductory portion of the independent claim.

### BACKGROUND OF THE INVENTION

May kinds of gates, barriers, booms and similar may be set in a latched state where the gate cannot be opened. The latching function may be purely mechanical and requires at least one mechanical latching element that latches the gate. Gates with a turnstile requires further mechanical parts to control the turnstile to rotate such that only one person at a time may pass. Gates with a latching function may also be electrically controllable, and then further requires a power source to control the latching function.

An object of the invention is therefore to provide a gate that is simpler in its design than prior art gates with a latching function.

These and other objects are attained by a gate according to the characterising portion of the independent claim.

### SUMMARY OF THE INVENTION

The invention relates to a gate (1a-b, 2a-b) with a stand (1a-b) and a rotatable part (2a-b) that is turnable or rotatable relative to the stand. The rotatable part (2a-b) is attached to the stand via a generator. The gate may be latched by electrically loading the electrical output of the generator, which advantageously does not necessitate a separate latch element, and the generator may further be used for generating electrical power that is used for control of at least control electronics in the gate.

The generator may further be arranged to break the rotatable part (2a-b), or alternatively act as a motor turning or rotating the rotatable part (2a-b),

The invention further relates to a gate where the generator is arranged to rotate an integer fraction of one full turn, which may advantageously be used with a turnstile.

### BRIEF DESCRIPTION OF THE DRAWINGS

FIG. 1 shows a first embodiment of the invention

FIG. 2 shows a second embodiment of the invention

### DESCRIPTION OF PREFERRED EMBODIMENTS

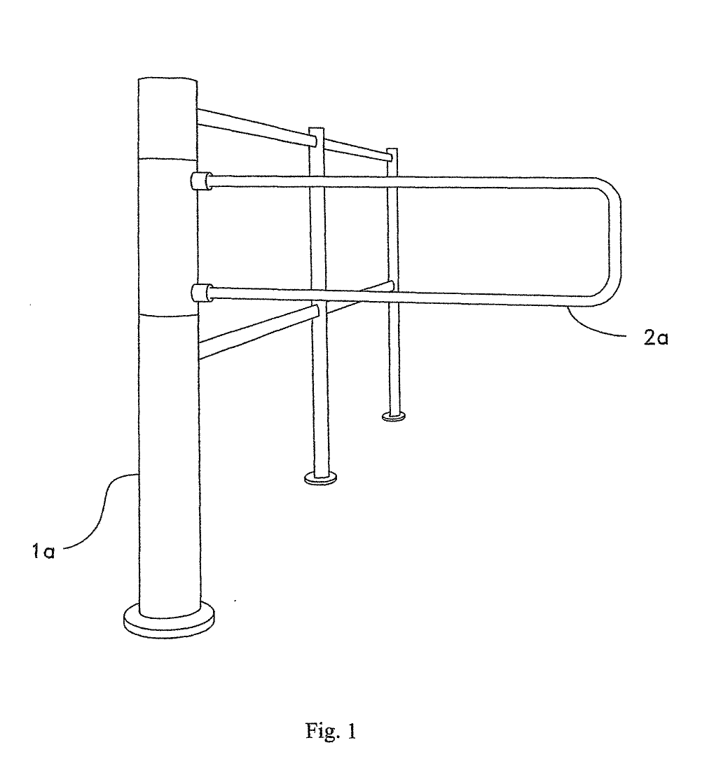

FIG. 1 shows a first embodiment of the invention embodied for use as an entrance gate. The entrance gate comprises a pole la fixed to the floor, at which a gate 2a is turnably arranged. The gate may be turned up to 90 degrees from closed position. a generator is arranged inside the pole, and the gate is attached to the axis of the generator. In order to allow a user to open the gate with little effort, the electrical output may be left open. The generator may also generate a small electrical power, without the user experiencing that a large effort is needed to open the gate. The generated power may be stored in a battery and used in the entrance gate.

In order to latch the entrance gate, the electrical output of the generator may be short circuited, and a large force is then necessary in order to open the gate. A gearbox may be arranged between the generator and the gate, and the force necessary to force the latched gate opened may then be increased to a desired level. The gate may thus be latched without a separate latching element and without providing power to the entrance gate.

The generator is typically embodied as a synchronous motor and the generator ma thus also be used as a motor. The generator may, when used as a motor, automatically open or close the gate. The power necessary for this may be drawn from the battery. If a larger force for latching the gate is needed than the generator is able to provide in short circuited state, the motor may be controlled such that it actively prevents the gate from leaving that closed state, again without needing a separate latching element.

If the gate is provided with a spring device that returns the gate to closed state after having been opened by a user, the gate tends to throw back and forth around the closed position as it is released. This may be counteracted using a separate, mechanical attenuation device but, more advantageously, the generator may be used to achieve this attenuation function. The generator may have a passive attenuation function if its electrical output is fixedly connected to a resistance. The generator may advantageously be connected to a resistance via a diode, such that it does not counteract opening of the gate, while dampening the return motion of the gate and prevents it from bouncing back and forth.

By allowing the generator to generate a small power, the user is not noticeably affected, but the small power may be used to control the generator. The control may achieve a varying attenuation effect on the gate, such that it is allowed to rapidly reach a maximum speed in order to rapidly close through the action of a spring, but smoothly brake as it reaches closed position. The small power that has been stored in the battery may also be used to drive the generator as a motor and thereby get the gate to return to its closed state in a controlled fashion without the need for a spring or a mechanical attenuation element.

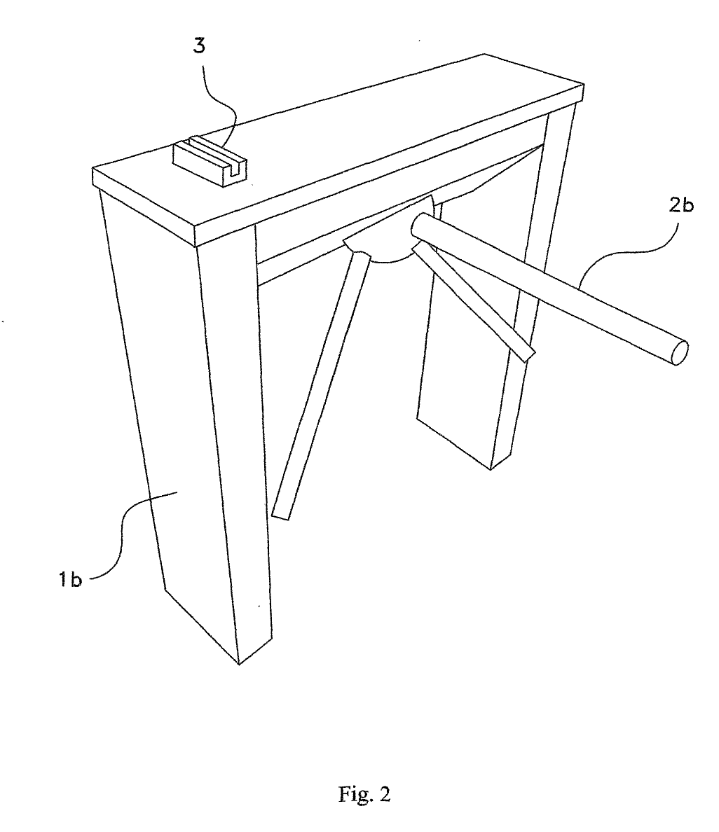

FIG. 2 shows a second embodiment of the invention embodied for use as a blocking device with a turnstile 2b. The blocker comprises a two legged stand lb at which a rotatably arranged turnstile with three legs is arranged. The turnstile may rotate around a centre axis and may be latched such that it is prevented from rotating and not allow a user through. At the blocker 1a a reading device 3 is arranged, that reads access cards and this needs only low power and communicates wirelessly with other equipment. As the turnstile is mechanically arranged on the axis of a generator, users allowed to pass the blocker may let the generator generate sufficient power to power the reading device, such that the blocker does not need to be connected to the power grid. In order to generate this small power, the users only have to be exposed to a very small resistance as they drive the turnstile to rotate.

In order to lock the turnstile, the electronics may short circuit the electrical output from the generator, which requires a minimal power and no separate latching element for locking the gate. The generator may also be driven as a motor and actively rotate the turnstile 2b.

The turnstile according to the illustrated embodiment has three legs and is intended to rotate one third of a turn at a time, in order to allow one user at a time. A purely mechanical device for making the turnstile rotate in this fashion is relatively complex, while a synchronous generator naturally moves in steps that constitute a turn divided by an integer, which for many types of designs is the number of poles divided by two. It is therefore simple to make the turnstile rotate a selected part of a full turn and then latch, by selecting a synchronous generator with a relevant number of poles.

The generated power from the generator may obviously also be used to power other units in the vicinity of the gate or even after conversion be provided to the power grind. There are many types of devices that both may generate mechanical power and, if driven by a mechanical force, generate electrical power. A typical example is synchronous motors that may act both as motors and generators. In order to simplify the text, in this document the concept of generator is used synonymously for either a device that may only be used as a generator or a device that may be used both as a generator and a motor. For the same reason, the concept denoted gate implies all kinds of gates, barriers, booms and similar. Obviously, the gate or barrier may be attached to the generator directly or via a gear box or any other intermediate element.

1. A gate (1a-b, 2a-b) with a stand (1a-b) and a rotatable part (2a-b) that is rotatable relative to the stand, where the rotatable part (2a-b) is attached to the stand via a generator, characterised in that said rotatable part (2a-b) is latchable by electrically loading the electrical output of the generator.

2. A gate according to claim 1, characterised in that said generator is arranged to generate electrical power which is used at least for controlling control electronics in the gate.

3. A gate according to claim 1, characterised in that said generator is arranged to break the rotatable part (2a-b).

4. A gate according to claim 1, characterised in that said generator is arranged to rotate the rotatable part (2a-b).

5. A gate according to claim 1, characterised in that said rotatable part (2a-b) is rotatable.

6. A gate according to claim 1, characterised in that said generator is arranged to rotate an integer fraction of one full turn.

7. A gate according to claim 2, characterised in that said generator is arranged to break the rotatable part (2a-b).
